(19) United States
(12) Patent Application Publication
(10) Pub. No.: US 2019/0118592 A1
(43) Pub. Date: Apr. 25, 2019

(54) Method, Tire-Mounted TPMS Component, and Machine Readable Storage or Computer Program for Determining a Duration of at Least one Contact Patch Event of a Rolling Tire

(71) Applicant: Infineon Technologies AG, Neubiberg (DE)

(72) Inventors: Benjamin Kollmitzer, Graz (AT); Christoph Steiner, St. Margarethen (AT)

(21) Appl. No.: 15/788,088

(22) Filed: Oct. 19, 2017

(51) Int. Cl. B60C 23/06

(52) U.S. Cl. CPC B60C 23/061; B60C 2019/004; B60Y 2400/304

(57) ABSTRACT

Examples provide a method, a component, a tire-mounted TPMS module, a TPMS system and a machine readable storage or computer program for determining a duration of at least one contact patch event of a rolling tire. A method for determining a duration of at least one contact patch event of a rolling tire, comprises obtaining a sequence of acceleration measurement samples of the rolling tire from a tire-mounted acceleration sensor; and determining the duration of the contact patch event based on acceleration measurement samples of the sequence between a first time instance when the acceleration measurement samples cross a first threshold and a second time instance when the acceleration measurement samples cross a second threshold.

### FIELD

Examples relate to tire pressure monitoring systems (TPMS) and to angular position sensing (APS), in particular but not exclusively, to a method, a tire-mounted TPMS component, and a machine readable storage or computer program for determining a duration of at least one contact patch event of a rolling tire.

### BACKGROUND

Tire pressure monitoring systems are traditionally used in automotive applications to monitor the inflation pressure of vehicle tires and to warn the driver in case of abnormal inflation.

For direct TPMS, modules—comprising at least of a sensor, control logic, a radio frequency (RF) transmitter and a source for electrical energy—are mounted in a tire. Each module measures the inflation pressure and transmits this value together with module identification (ID) via RF to the electronic control unit (ECU) in the vehicle.

Standard TPMS modules are valve-based, i.e. mounted on the valve and thus fixed to the rim. In contrast to valve-based TPMS modules, tire-mounted modules are mounted in the tire cavity on the inner liner of the tire.

With valve-based TPMS modules, one can infer the angular position from the direction of the earth's gravity, which is measured with accelerometers. The accelerations acting on such modules comprise mainly the centrifugal acceleration due to the spinning wheel, mechanical vibrations, and the earth's gravity.

Due to the more flexible mounting position of tire-mounted TPMS modules, the relevant sources for accelerations are different. As the tire spins during vehicle movement, such tire-mounted TPMS modules follow roughly a trajectory determined by the tire's circumference. In the vehicle-frame, i.e. a coordinate system which is fixed to the vehicle, the tires' circumferences and thus the trajectories resemble flattened circles, where the flat is determined by the contact patch (footprint) between the tire and the ground. Tire-mounted TPMS modules are thus subject to fundamentally different acceleration waveforms than valve-based TPMS modules.

Knowledge of the contact patch length is of interest because it enables load detection: The tire can only transfer loads via the contact patch to the road. Because the tire is flexible, the area of the contact patch varies with the applied loads, the inflation pressure etc. Vice versa, knowledge of the contact patch, inflation pressure, and the mechanical properties of the tire allows the vehicle to estimate the acting tire load. This information could potentially increase safety, energy efficiency and comfort; e.g. by detecting overload, adjusting the suspension and suggesting appropriate inflation pressures for optimal traction and CO₂ efficiency.

### SUMMARY

Examples relate to tire pressure monitoring systems (TPMS) and to angular position sensing (APS), in particular, but not exclusively, to a method, a tire-mounted TPMS component, and a machine readable storage or computer program for determining a duration of at least one contact patch event of a rolling tire.

Examples provide a method for determining a duration of a contact patch event of a rolling tire, the method comprising obtaining a sequence of acceleration measurement samples of the rolling tire from an acceleration sensor mounted in the tire, and determining the duration of the contact patch event based on acceleration measurement samples of the sequence between a first time instance when the acceleration measurement samples cross a first threshold and a second time instance when the acceleration measurement samples cross a second threshold. In some examples, the duration can be determined based on the samples themselves (for example, by means of a known sampling rate). The time instances themselves need not be known.

In some examples, the slope of the sequence of acceleration measurement samples crossing the first threshold can be of different sign than the slope of the acceleration measurement samples crossing the second threshold. For example, the slope of the measurement samples crossing the first threshold can be positive, while the slope of the acceleration measurement samples crossing the second threshold can be negative.

In some examples, at least one of the first or second thresholds can correspond to an average value of the acceleration measurement samples obtained during one or more rotations of the tire. The skilled person having benefit from the present disclosure will appreciate however that different first or second thresholds can be employed as well.

In some examples, the first and the second threshold can be different, similar to a Schmitt trigger. In other example embodiments, the first and the second threshold may be the same.

In some examples, the first time instance can be smaller than the second time instance and the first threshold can have a smaller absolute value than the second threshold.

In some examples, the determination of the duration of the contact patch event can comprise determining the first time instance when the acceleration measurement samples cross the first threshold. The second time instance can be determined when the acceleration measurement samples cross the second threshold. The duration can be determined from a difference between the first and second time instances. Thus, the determination can be made using only two effective samples. This is computationally cheap and robust against unexpected changes in the signal waveform.

In some examples, the determination of the duration of the contact patch event can be based on the number of samples between the first and the second time instance and a known sampling rate. The time instances themselves do not need to be known.

In some examples, the determination of the duration of the contact patch event can comprise determining a weighted integral of the acceleration measurement samples between the first and the second time instance. The weighting factor can correspond to the inverse of the difference between the first or the second threshold and an acceleration value corresponding to zero acceleration.

In some examples, the first threshold can equal the second threshold. The first and the second time instance can be determined by extremizing an integral of the sequence of acceleration measurement samples with respect to a threshold. The duration of the contact patch event can be determined by dividing the value of the integral by a difference between the first or the second threshold and an acceleration value corresponding to zero acceleration.

In some examples, the first threshold can equal the second threshold. The determination of the duration can comprise determining a difference between the first or the second threshold and each sample of the sequence of acceleration measurement samples. The difference can be accumulated into an accumulated sum. The accumulated sum can be set to zero whenever the accumulated sum becomes negative. Accumulating the accumulated sum can be stopped when the sequence of acceleration measurement samples reaches the second time instance. The accumulated sum can be divided by the difference between the second threshold and an acceleration value corresponding to zero acceleration. Embodiments based on this method may result in a noise robust, precise, and reproducible determination of the contact patch duration.

In some examples, the first time instance may be updated to the time corresponding to the sample that caused the accumulated sum to be set to zero. The duration may be determined from the difference between the first and the second time instances once the accumulation has stopped.

In some examples, a first set of samples can be obtained, processed, and discarded before a subsequent set is obtained. The skilled person having benefit from the present disclosure will appreciate that each set may comprise precisely one sample as well as a plurality of samples (such as those representing a single rotation of the tire), or some other grouping. For example, the samples could be obtained, processed, and discarded one by one before a subsequent sample is obtained. With such embodiments no or only little memory may be required.

In some examples, a set equating to one sample can be obtained, the difference between the sample and the first or the second threshold determined, the accumulated sum updated by the difference, and the sample discarded before the next sample (set) is obtained.

In some examples, a time window of a subsequent contact patch event containing the first and the second time instance (or threshold crossing) of a subsequent contact patch event can be estimated. The sample rate can be increased during the estimated time window with respect to a reduced sample rate outside the estimated time window. This can save energy when outside a contact patch event.

In some examples, the time window can be estimated by determining the rotational rate of the tire, identifying at least one sample within the sequence of acceleration measurement samples taken of the rolling tire, indicative of a minimum radial acceleration and estimating the time window of the subsequent contact patch event based on the identified sample and the rotational rate of the tire. The time window can be estimated using minimal energy and with as little as one sample in the contact patch.

In some examples, the estimated time window can be validated and the method/process can be aborted if the time window exceeds a predetermined threshold.

In some examples, the samples and the sequence of samples can be validated and the method aborted if the samples exceed a predefined threshold. It should be understood that there are numerous ways to check the samples, such as by comparing each sample, the average of the sequence of samples, or the variance of the sequence of samples, amongst others, to a predetermined threshold. The method can be aborted and energy saved in the case of nonsensical data or insufficient signal to noise ratio.

In some examples, the determination of the duration of the contact patch event can be validated and the method/process aborted if the duration exceeds a predetermined threshold.

In some examples, the determination of the duration of the contact patch event may be validated by comparing at least two estimates of the duration of at least one contact patch event wherein each estimate is obtained by a different estimation method/process. The method of determining the duration can be aborted if the at least two estimates differ by more than a predetermined threshold. For reasonable signal quality, different methods should yield similar results within a certain accuracy. Larger differences indicate problematic signal quality, e.g. due to a pothole, implying that the results should be ignored.

In some examples, the at least two estimates of the contact patch duration comprise a first estimate obtained by determining the first time instance when the acceleration measurement samples cross the first threshold, determining the second time instance when the acceleration measurement samples cross the second threshold after the first time instance, and estimating the duration from a difference between the first and the second time instance. A second estimate can be obtained by determining a difference between the first or the second threshold and each sample of the sequence of acceleration measurement samples, accumulating the difference into an accumulated sum, setting the accumulated sum to zero whenever the accumulated sum is negative, stopping accumulating the accumulated sum when the sequence of acceleration measurement samples reaches the second time instance and dividing the accumulated sum by the difference between the first threshold and an acceleration value corresponding to zero acceleration. Additionally, or alternatively, other methods may be used to obtain the estimates of the duration, such as by extremizing an integral or a least squares fit.

According to a further aspect, the present disclosure proposes a tire-mounted TPMS component. The TPMS component comprises a tire-mounted acceleration sensor. The acceleration sensor is configured to generate a sequence of acceleration measurement samples taken of the rolling tire. The TPMS component also comprises an electronic control unit configured to determine the duration of the contact patch event based on acceleration measurement samples of the sequence between a first time instance when the acceleration measurement samples cross a first threshold and a second time instance when the acceleration measurement samples cross a second threshold.

In some examples, the electronic control unit can be further configured to estimate a time window of the subsequent contact patch event based on the sequence of acceleration measurement samples. The estimated time window can comprise at least two time instances corresponding to the first and second time instance of a subsequent contact patch event. The sensor can further be configured to increase a sample rate of the sequence of acceleration measurement samples during the estimated time window with respect to a reduced sample rate outside the estimated time window.

According to a further aspect, the present disclosure proposes a machine readable storage including machine readable instructions to determine a duration of a contact patch event of a rolling tire, that when executed obtains a sequence of acceleration measurement samples of the rolling tire and determines the duration of the contact patch event based on acceleration measurement samples of the sequence between a first time instance when the acceleration measurement samples cross a first threshold and a second time instance when the acceleration measurement samples cross a second threshold.

As used herein, a tire may be, in addition to any common usage in the art, any deformable rotating device, particularly one that deforms when it comes in contact with a surface. A tire does not have to be made of rubber or any particular material.

### BRIEF DESCRIPTION OF THE FIGURES

Some examples of apparatuses and/or methods will be described in the following by way of example only, and with reference to the accompanying figures, in which

FIG. 1 shows a schematic cross-section of a tire with a tire-mounted TPMS module;

FIG. 2 shows a representative graph of the radial acceleration profile of the tire;

FIG. 3 shows a flowchart of a method for determining the duration of a contact patch event of a tire;

FIG. 4A shows an example sequence of acceleration measurement samples;

FIG. 4B shows a flowchart of a trigger method for determining the duration of a contact patch event;

FIG. 5A shows another example sequence of acceleration measurement samples;

FIG. 5B shows a flowchart of an area estimation method for determining the duration of a contact patch event;

FIG. 6 shows a graph comparing the accuracy of three different methods for determining the duration of a contact patch event;

FIG. 7 shows a flow chart of a method to vary the sampling rate based on estimated need;

FIG. 8 shows a flow chart of a method to validate the determination of the duration of a contact patch event;

FIG. 9 shows an exemplary flowchart of a method for predicting and determining the duration of the contact patch event.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong. In the following figures optional components, actions or steps are shown in broken lines.

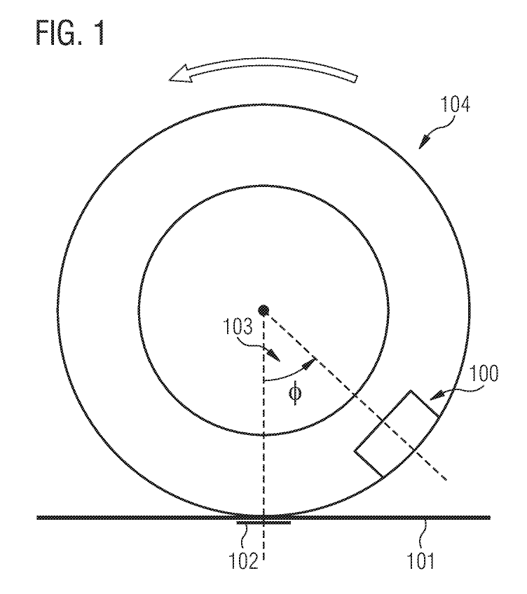

FIG. 1 shows a schematic cross-section of a tire 104 with a tire-mounted TPMS module 100. The tire 104 with the tire-mounted TPMS module 100 rolls on a surface or road. The tire 104 forms a contact patch 102 with the road 101 as it rotates. An angle 103 is formed between the tire-mounted module 100 and the normal to the road. The angular position ϕ can be defined as the angle spanning between the TPMS module and the vertical axis. A “contact patch event” occurs when the tire-mounted module 100 is located in the contact patch 102. In other words, the contact patch event occurs when the outer surface of the tire where the module 100 is mounted touches the road surface 101. The contact patch length is the length of the tire that flattens within the contact patch 102. The contact patch duration is the amount of time that the TPMS module 100 is within the contact patch 102 during rotation of the tire.

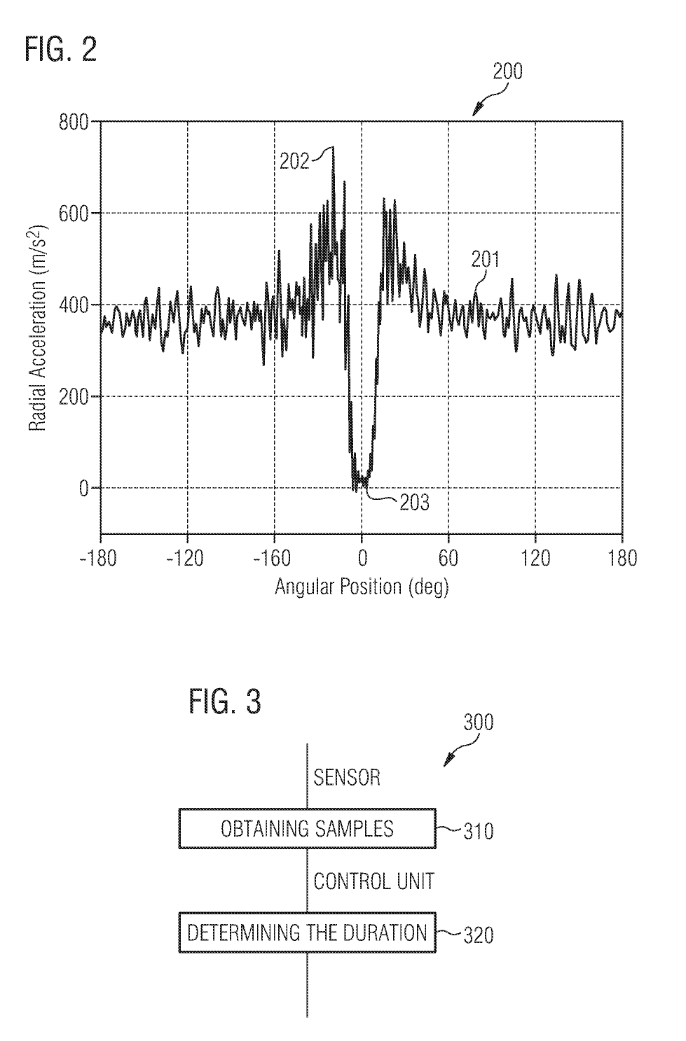

FIG. 2 is a representative graph 200 of the radial acceleration profile of the tire plotted against the angular position (in degrees). FIG. 2 shows a typical acceleration-signal acquired by a radial accelerometer or acceleration sensor of a tire-mounted TPMS module. Ignoring higher frequency components, most of the data is constant and lies close to a baseline or average 201 (close to 400 m/s² for the exemplary signal in FIG. 2), when the tire-mounted TPMS module 100 is not in the contact patch. As the module 100 enters the contact patch event, a sharp spike in the acceleration profile occurs at 202 followed by a near-zero reading during the contact patch event 203.

The acceleration of a tire-mounted TPMS module is nearly constant for the largest part of the tire revolution (apart from mechanical vibrations). In this part, the acceleration is mainly determined by the centrifugal acceleration. The centrifugal acceleration a_{cf} on a circular trajectory with a radius R and a velocity v is given by the equation

a_{cf}=v²/R. (1)

In the contact patch, however, when the module 100 is close to the road surface, the acceleration experienced by the TPMS module 100 is nearly zero. Shortly before entering and leaving the contact patch 102, the tire has to deform significantly. This increases the local curvature of the TPMS module's trajectory. Thus, the experienced acceleration is also increased.

Under slip-free conditions, the tire itself rolls over sections which touch the road surface (i.e. the contact patch), while these sections are virtually stationary. Thus, a TPMS module experiences virtually no acceleration when passing through this contact patch (i.e. the contact patch event). Further assuming a freely rolling wheel, i.e. a wheel on which no torque is applied, this contact patch coincides with the angular position defined as ϕ=0 (i.e. the angle formed normal to the ground). Because the nearly vanishing acceleration during the contact patch event is so prominent, the subsequent angular position and the duration of the contact patch event can be estimated.

FIG. 3 shows a flow chart of a method 300 for determining the duration of a contact patch event of a rolling tire. The method 300 comprises obtaining 310 a sequence of acceleration measurement samples of the rolling tire from a tire-mounted acceleration sensor. Method 300 further comprises determining or estimating 320 the duration of the contact patch event based on acceleration measurement samples of the sequence between a first time instance when the acceleration measurement samples cross a first threshold and a second time instance when the acceleration measurement samples cross a second threshold.

The acceleration measurement samples may be directly measured or generated by the tire-mounted acceleration sensor during rotation of the tire and output from the sensor interface to a control unit. By directly measuring and processing the samples, minimal memory may be used. In other examples, the samples may be stored in memory and recalled later for processing. The control unit may be tire-mounted, but in other examples it may be located at a remote location. It should be appreciated that the acceleration measurement samples do not necessarily need to measure the acceleration itself, but could instead be any measured quantity indicative of the (radial) acceleration (i.e. any quantity from which the acceleration component could be derived or determined could correspond to an acceleration measurement sample).

It should be appreciated that although samples taken during at least one complete rotation of the rolling tire guarantee that contact patch data is sampled, it is possible to determine the duration without sampling a complete a rotation of the rolling tire. In some examples, it is possible to predict the contact patch event and to take samples only during the predicted contact patch event, saving energy. In some examples, it is possible to take and process samples on the fly until the duration or the second time instance are determined, at which point the sampling can be stopped, again saving energy.

One of skill in the art can understand that the duration may be determined or estimated by a variety of methods based on the acceleration measurement samples. As will become apparent in the remainder of this disclosure, there are various concepts for explicitly or implicitly determining the first and the second time instances. For example, if the number of the samples between the first and second time instance are known, then one only needs the sampling rate (which is known) in order to estimate the duration. The time instances themselves do not need to be known explicitly. On the other hand, if one knows the actual time of the first and second instances, then the duration can be found by trivial subtraction. Some methods may rely on a combination of the above information as explained in detail below.

Due to the limited power and memory of the tire-mounted TPMS component, techniques which are computationally efficient, light on memory, and reduce power usage are highly desired. Examples comprise, amongst others, a trigger method, an area estimation method, an integration method, and a least square fit method each providing a different computational efficiency and accuracy. One skilled in the art can appreciate that numerous variations to these methods may be implemented.

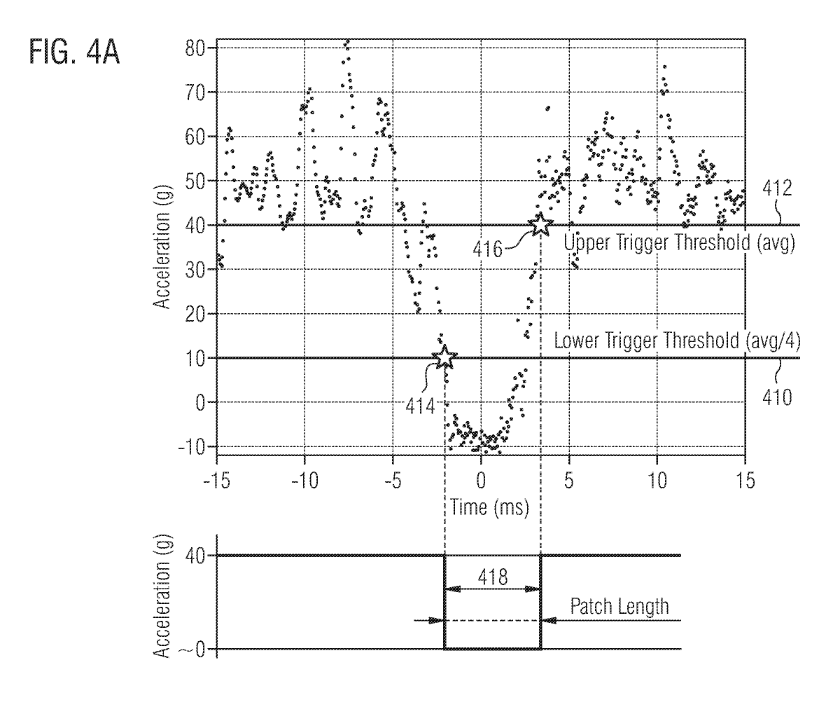

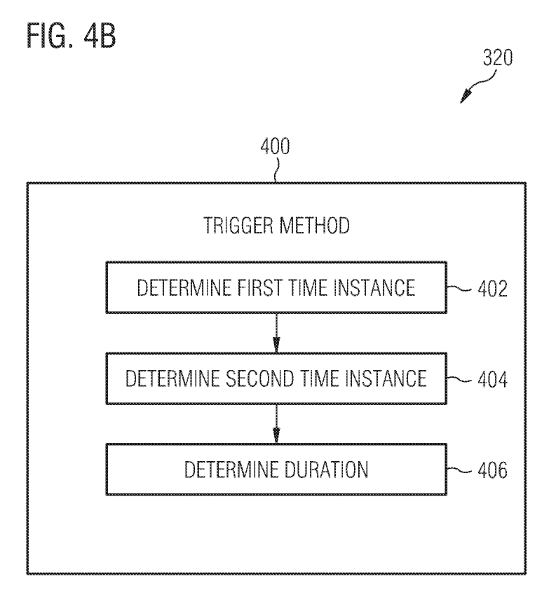

FIG. 4A shows an example sequence of acceleration measurement samples corresponding to a fraction of one tire revolution, which could also be referred to a frame of acceleration measurement samples. As can be appreciated from this example, a complete tire revolution can comprise tens, hundreds or even thousands of discrete acceleration measurement samples. As can be seen from FIG. 4A, a first threshold 410 (Lower Trigger Threshold, LTT) and a second threshold 412 (Upper Trigger Threshold, UTT) can be defined. The UTT 412 can be set to an upper boundary. In the example of FIG. 4A, it is set equal to an afore determined average acceleration. The LTT 410 can be set to a value between the UTT and a value corresponding to zero acceleration. In the example of FIG. 4A, the LTT 410 is set equal to ¼ of the UTT 412 (i.e. ¼ of the average). The skilled person having benefit from the present disclosure will appreciate, however, that other threshold values are possible and even beneficial in other implementations.

FIG. 4B illustrates an example of the trigger method 400, also called the Schmitt trigger method. Examples of the trigger method 400 comprise determining 402 a first time instance 414 when the acceleration measurement samples cross the first threshold (LTT) 410. After the first time instance 414 is determined, a second time instance 416 when the acceleration measurement samples cross the second threshold (UTT) 412 is determined 404 as well. Then, the duration can be determined in 406 from a difference between the first and the second time instance.

The skilled person having benefit from the present disclosure will appreciate that determining the first and second time instances can be done explicitly or implicitly. For example, the first/second time instance can be determined by considering a sample number of the acceleration measurement sample crossing the first/second threshold together with the sample rate. In other implementations, only the number of samples in between the two threshold crossings may be considered. The duration can then be determined by multiplying the number of samples in between the two threshold crossings with the sample rate.

An example of method 400 may be summarized by the following pseudo-code, where UTT corresponds to the upper trigger (second) threshold 412, LTT corresponds to the lower trigger (first) threshold 410, and acc corresponds to the acceleration measurement sample being analyzed:

Sample until acc > UTT
Sample until acc < LTT

index1

Sample until acc > UTT

index2

length ∝ index2 − index1
If length < min_length

then return to step 2.

The trigger method relies on the two thresholds, 410 and 412. Acceleration measurement samples smaller than the first (LTT) threshold 410 turn the trigger on. Acceleration measurement samples larger than the second (UTT) threshold 412 turn the trigger off. The trigger maintains its state in between. Thus, while the trigger is off the method checks for acc<LTT and while the trigger is on the method checks for acc>UTT. Finally, the duration is compared to a predetermined reasonable value to ensure validity of the data. Adjustable minimal and maximal contact patch durations can be used to increase the robustness against noise and other disturbances in the acceleration signal.

In performing the trigger method 400, the trigger initially begins in the off state. In the off state, the acceleration samples are checked until a sample crosses the first (LTT) threshold 410, as seen by point 414 in FIG. 4A. Once a sample crosses below the LTT, the first time instance 414 is noted and the trigger is changed to the on state. In the on state, samples are checked until a sample crosses above the second (UTT) threshold 412, as seen by point 416 in FIG. 4A. Once a sample crosses above the UTT while the trigger is turned on, the second time instance 416 is noted and the trigger is turned off. Thus, the duration can be determined by a time difference between the first and second time instances, as shown below the graph by 418.

As can be seen in FIG. 4A, the slope of the sequence crossing the first threshold 410 is of a different sign than the slope of the sequence crossing the second threshold 412. As can also be seen, the first threshold 410 has a smaller absolute value than the second threshold 412, and the first time instance 414 occurs before the second time instance 416.

The upside of the trigger method 400 is that it is robust against unexpected changes in the signal waveform and computationally cheap. On the other hand, its result is only based on two effective samples, thus considerably influenced by noise.

To minimize memory and power use, the samples can be analyzed after each sample is measured and the sample discarded. By analyzing and discarding each measurement sample as it is taken, one can avoid storing the entire sequence in memory. Alternatively, one can measure a set of samples at time, wherein a set can correspond to a single sample only or to samples taken within a certain period (such as one rotation of the tire).

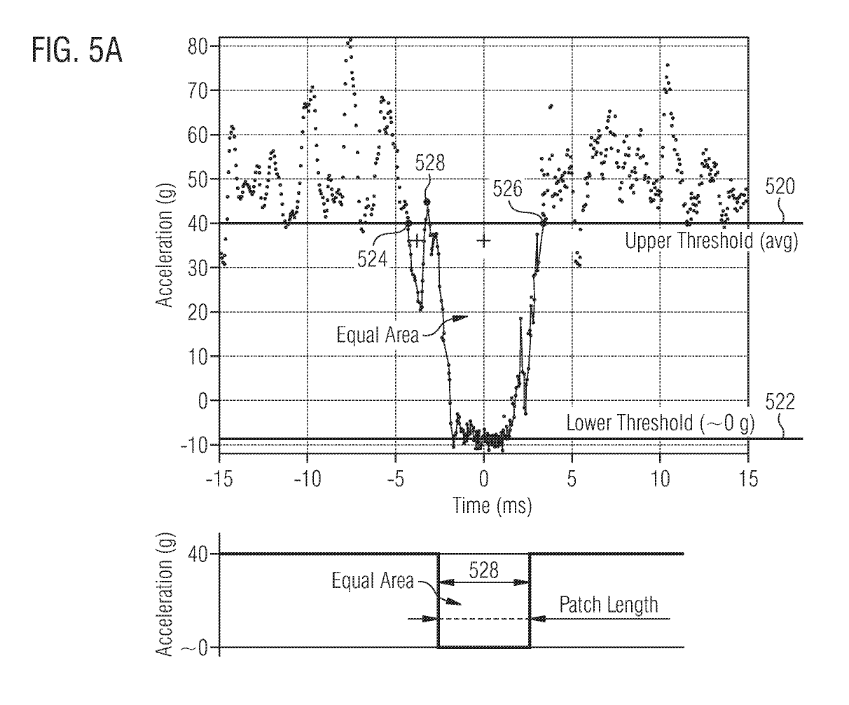

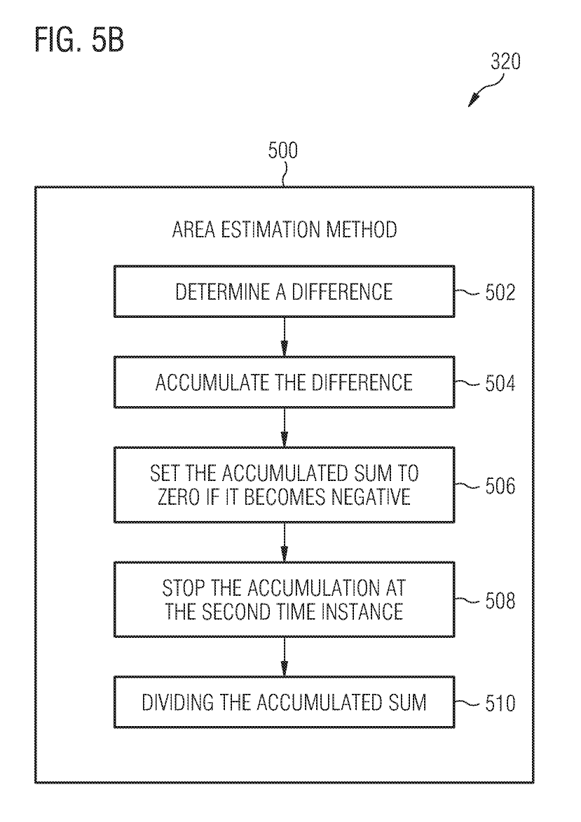

FIG. 5A shows another example sequence of acceleration measurement samples corresponding to a fraction of one tire revolution. Here, the first and the second threshold are both set equal to a single threshold 520 corresponding to the average acceleration (similar to the UTT of the trigger method). Another option to determine the duration of the contact patch event is to determine the duration between a first time instance 524 when the acceleration measurement samples fall below the threshold 520 and a second time instance 526 when the acceleration measurement samples exceed the threshold 520. This can involve integrating or accumulating the acceleration measurement samples.

FIG. 5B shows an example of an area estimation method 500, wherein the first and second thresholds are the same (threshold 520). This method involves first an act 502 of finding the difference between the threshold 520 and each measured acceleration sample. In a next act 504 these differences are accumulated into an accumulated sum. If the accumulated sum becomes negative, then it is reset to zero (see 506) and the accumulation restarts from 0 with the subsequent acceleration measurement sample. The first time instance 524 can implicitly correspond to the last accumulation restart. The accumulation 508 continues until the second time instance 526 is reached.

One skilled in the art can appreciate that the second time instance 526 can be determined by a number of different methods; one such method is by using the second time instance as found in the trigger method as described above.

Once the second time instance 526 is reached and the accumulation has been stopped, the accumulated sum represents the area under the graph with respect to the threshold 520. The height of this area corresponds to a difference between threshold 520 and value 522 corresponding to zero acceleration. The width of this area corresponds to time. Since area equals height times width, we can divide the accumulated area by the height to obtain the width. Thus, one can divide the accumulated sum by the difference between the threshold 520 and the acceleration value 522 corresponding to zero acceleration (i.e. the height) to obtain the time duration of the contact patch event.

The area estimation method 500 may be summarized by the following pseudo-code, wherein acc_sum corresponds to the accumulated sum, avg corresponds to the average of the acceleration measurement samples (i.e. the first or second threshold) and acc corresponds to the acceleration measurement sample being analyzed:

Set acc_sum = 0
For every sample:

acc_sum += (avg − acc)
If acc_sum < 0

then acc_sum = 0

After summation:

duration = acc_sum/avg

To minimize memory and power use, the samples can be analyzed after each sample is measured, the difference between the threshold and the measured sample determined, this value added to the accumulated sum and the sample discarded. By analyzing and discarding each measurement sample as it is taken, one can avoid storing the entire sequence in memory. Alternatively, one can measure a set of samples at time, wherein a set can correspond to a single sample only or to samples taken within a certain period (such as one rotation of the tire).

In performing the method 500, the difference between the threshold 520 and the measured samples is found and this value is accumulated. As can be seen by the graph of the samples in FIG. 5A, this accumulated sum will be negative for samples before the sample labeled at 524. Thus, the accumulated sum will be repeatedly set to zero until the sample at point 524.

After the sample at 524, the accumulated sum begins to become positive. Although a small negative peak 528 exists shortly after 524 (at approximately −3 ms), the area of this peak is not large enough to negate the accumulated sum, and thus, the accumulated sum is not reset to zero. The accumulation continues until the second time instance 526 (corresponding to time 416 of the trigger method).

Finally, the accumulated area is divided by the height (i.e. the difference between 520 and 522) leading to the duration 528.

Additionally, or alternatively, the first time instance may be updated to correspond to the most recent sample which causes the accumulated sum to be set to zero. Thus, the duration may be determined by the difference between the first and second time instances without needing the value of the accumulated sum explicitly.

It should be appreciated that other methods for determining the duration may be possible, but the above-mentioned methods are particularly efficient and take into consideration the limited resources available at the tire-mounted TPMS component. Other methods may comprise, for example, extremizing the integral or fitting the data according to the least square fit method. These methods may provide more accurate results, but they are not always practical to use given the limited resources of tire-mounted TPMS components.

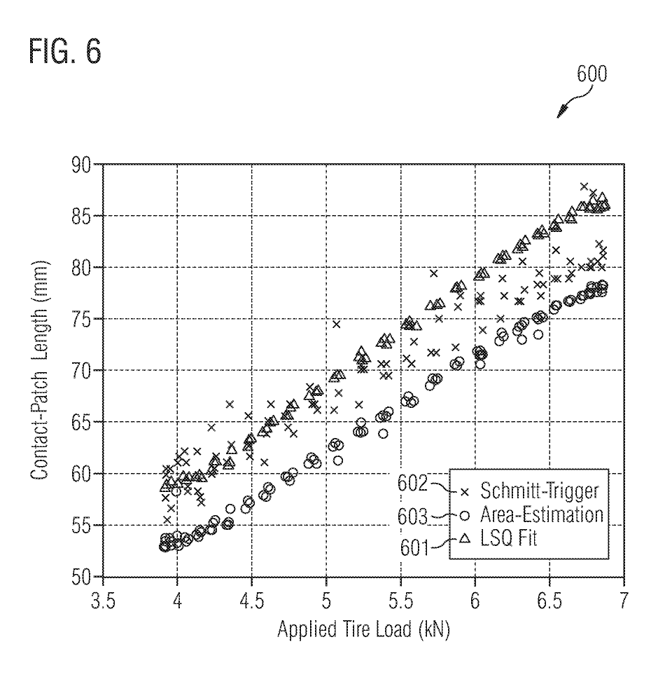

FIG. 6 shows a representative graph 600 of the results of three different methods of obtaining the durations of contact patch events. The first method 601, labeled by triangles, shows the use of a traditional Least Square Fit method which is computationally intensive, but provides a high-level of accuracy. The second method 602, labeled by X's, shows the use of the trigger method as outlined in 400, above. Being computationally cheap and conceptually simple, this method is influenced by noise to a considerable degree and thus not as precise, but efficient to run. The third method 603, labeled by circles, shows the use of the area estimation method as outlined in 500, above. This method reaches a precision comparable with the computationally demanding Least Square Fit method 601. The systematic differences between the three methods stem from the different threshold levels, at which the “contact patch durations” are evaluated by the different methods. The examples denoted in graph 600 are representative of the exemplary methods denoted above; one skilled in the art can appreciate that deviations from these methods can occur which can result in over- or under-estimations of their results with varying computational needs.

The above methods require a high sampling frequency but relatively few computations per sample. While this enables processing the data during sample acquisition, switching the processing circuit to a low-power state while performing these methods might be inefficient. In order to minimize power use, it would be better to run these methods for as short as possible; ideally starting immediately before a contact patch. Predicting the next contact patch event allows one to wait in a low-power mode for the expected event, and only then execute the method in high-power mode.

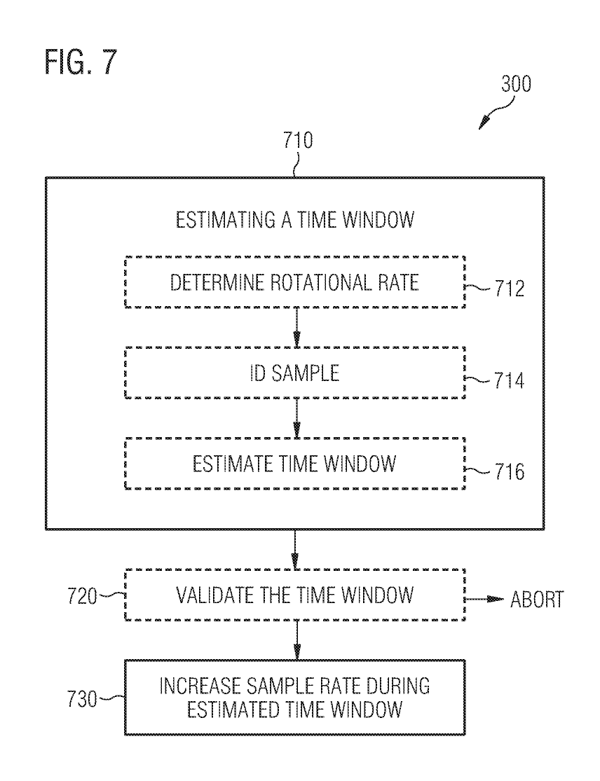

FIG. 7 shows a flow chart of an optional method for varying the sample rate while performing the method 300. First, a time window 710 is estimated corresponding to a subsequent contact patch event.

One way to estimate this time window is by 712 determining a rotational rate of the tire. By knowing the rotational rate of the tire, one can predict when the tire will be in the same position on its next rotation.

One way to determine the information on the rotational rate of the tire may be by deriving Tᵣₑᵥ from the average radial acceleration <a> and the geometrical tire radius R via the formula

Tᵣₑᵥ=2π\sqrt{R/ [symbol] a [symbol]}. (2)

For tire-mounted TPMS modules, the average radial acceleration agrees reasonably well with the centrifugal acceleration calculated from Eq. Error! Reference source not found., where R is approximated by the geometrical tire radius and v by the tire's velocity. Therefore, the velocity can be calculated from the average radial acceleration. Without slip, the velocity v is related to the period of the revolution Tᵣₑᵥ and the effective tire radius R_{eff} via the equation

v=2πR_{eff}/Tᵣₑᵥ. (3)

For a well-inflated tire, this effective radius is only marginally smaller than the geometrical radius. Thus, set R_{eff}=R in Eq. (3), and calculate Tᵣₑᵥ from the average acceleration <a> according to Eq. (2). Instead of the arithmetic mean <a>, in other examples one could use the median in this equation. This could improve the robustness against outliers at slightly increased computational demand.

Next, 714 identify within a sequence of acceleration samples at least one sample indicative of a minimum radial acceleration (i.e. at least one sample corresponding to the zero acceleration dip as shown in FIG. 2 at 203). Thus, 716 a time window can be estimated based on the position of the contact patch event and the known rotational rate of the tire.

It should be appreciated that there are numerous ways to estimate this time window aside from using the rotational rate. For example, if one knows the contact patch events of at least two consecutive rotations of the tire, then the time difference between these two events may be used as an estimate for the subsequent contact patch.

Once a time window 710 has been estimated, an optional 720 validation check may be performed. The estimated time window may be checked against a predetermined duration and the method aborted if the estimated window is outside the predetermined duration. For example, if the estimated time window is longer than the time it takes for the tire to perform a complete rotation, it can be immediately determined that the estimate is wrong and the method aborted to prevent erroneous data and to save energy.

Once a time window 710 has been estimated and (optionally) validated, the 730 sampling rate may be increased during the estimated time window with respect to a reduced sampling rate outside the time window. Thus, the method may obtain samples at a sufficiently high sampling rate during the predicted contact patch event while saving energy and avoiding unnecessary samples outside of the predicted contact patch event.

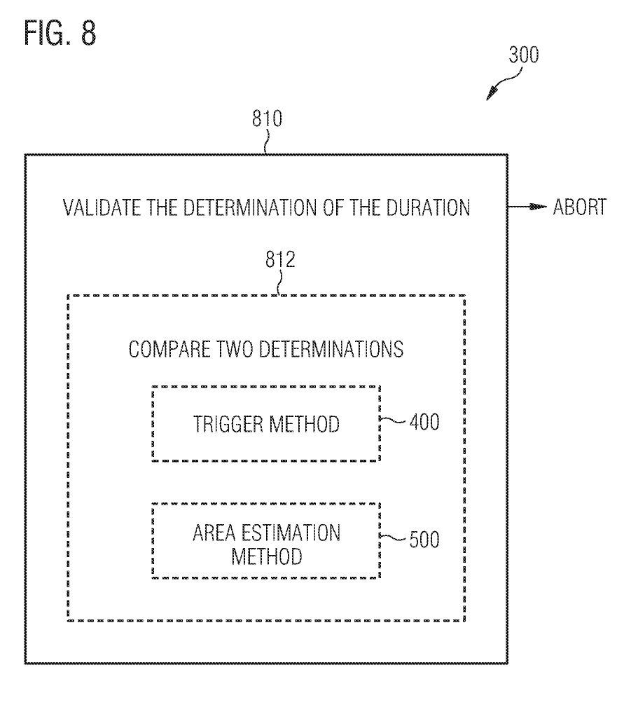

FIG. 8 shows a flow chart of an optional method for 810 validating the determination of the duration as obtained from method 300 at 320. The method may be aborted if the determined duration exceeds a predetermined threshold. For example, general data representative of contact patch lengths (or durations) corresponding to various loads on a tire may be determined using a test rig, and compared to the durations as determined by the method 300.

One method for validating the determination of the duration may comprise 812 comparing two different determinations obtained by two different methods for the same contact patch event of the tire. Since the two determinations represent the same contact patch event, they should be within an error threshold of each other. If the two determinations differ by more than a predetermined amount, then at least one determination is erroneous and the method may be aborted. An example of the comparison 812 may comprise a first determination using the trigger method 400 and a second determination using the area estimation method 500. It should be noted that, while the trigger and area estimation methods are provided as examples, any two determinations obtained using different methods may be used to 810 validate the determination.

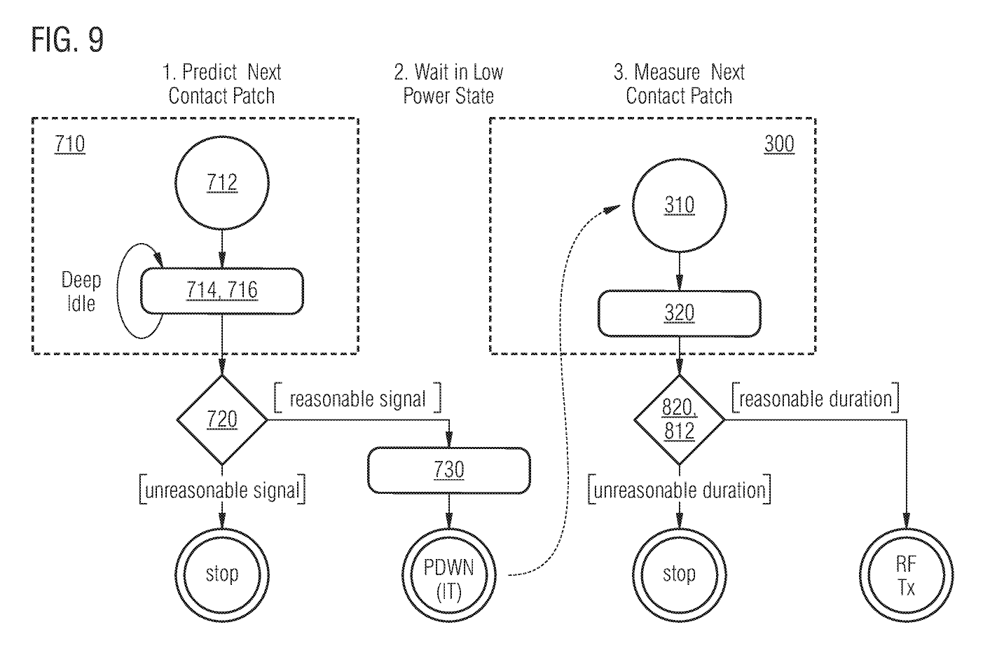

FIG. 9 shows a flowchart of an exemplary method employing numerous optional steps as described above. The method begins by first 710 estimating a time window of a subsequent contact patch event. The time window is estimated by 712 determining a rotational rate of the tire and 714 identifying a sample indicative of a minimal acceleration. The 716 time window is estimated based on the 712 rotational rate and 714 identified sample.

Next, the data is validated. This validation may encompass one or many validation steps. For example, the acquired samples may be checked against predetermined thresholds individually or as a sequence. Additionally, or alternatively, the 720 estimated time window may be validated. As with all validation steps, if the data exceeds a predetermined error threshold, the method is aborted to save power and avoid nonsensical or extraneous data (such as those due to uneven road conditions or other unexpected forces).

Once an appropriate time window estimate is achieved, the 730 sampling rate is modified accordingly such that a high sampling rate is achieved during the subsequent contact patch event while a reduced sampling rate is used otherwise. Thus, the system stays in low power (i.e. low sampling rate) until the estimated time arrives. This is shown by PDWN (IT) which represents the powering down of unnecessary circuits, with a wake-up scheduled by an internal timer according to the estimated time window.

Once the estimated contact patch approaches, the system switches to high sampling rate and begins to perform the method 300. As explained above, this begins by 310 obtaining samples and then 320 determining the duration based on the samples using one or more of the aforementioned methods (such as the 400 trigger and/or 500 area estimation methods).

Finally, once a duration is determined, it is also validated. As explained above, the 810 validation of the duration may comprise 812 a comparison of determinations using at least two different methods for the same contact patch event. As with all validation steps, if the two determinations vary by more than a predetermined threshold, the method is aborted.

In performing any of the above methods, one skilled in the art can appreciate that the thresholds can be changed, which might result in an over- or under-estimation of the contact patch duration. For example, one can move the first and second threshold of the trigger method further way from each other, which will result in a larger duration determination (and thus an over-estimate). One can move the thresholds closer together, which will result in a smaller duration determination (and thus an under-estimate). Similar changes can be made to any of the above described methods.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for determining a duration of a contact patch event of a rolling tire, comprising:
obtaining a sequence of acceleration measurement samples of the rolling tire from a tire-mounted acceleration sensor; and
determining the duration of the contact patch event based on acceleration measurement samples of the sequence between a first time instance when the acceleration measurement samples cross a first threshold and a second time instance when the acceleration measurement samples cross a second threshold.

2. The method of claim 1, wherein a slope of the sequence of acceleration measurement samples crossing the first threshold is of different sign than the slope of the acceleration measurement samples crossing the second threshold.

3. The method of claim 1, wherein at least one of the first and the second threshold corresponds to an average value of the acceleration measurement samples obtained during one or more revolutions of the rolling tire.

4. The method of claim 1, wherein the first and the second threshold are different from each other.

5. The method of claim 1, wherein the first time instance is smaller than the second time instance and wherein the first threshold has a smaller absolute value than the second threshold.

6. The method of claim 1, wherein determining the duration comprises
determining the first time instance when the acceleration measurement samples cross the first threshold,
determining the second time instance when the acceleration measurement samples cross the second threshold after the first time instance, and
determining the duration from a difference between the first and the second time instance.

7. The method of claim 1, wherein the duration is determined based on the number of samples between the first and the second time instance and a known sampling rate.

8. The method of claim 1, wherein the first threshold equals the second threshold, wherein determining the duration comprises:
determining a difference between the first or the second threshold and each sample of the sequence of acceleration measurement samples;
accumulating the difference into an accumulated sum;
setting the accumulated sum to zero whenever the accumulated sum is negative;
stopping accumulating the accumulated sum when the sequence of acceleration measurement samples reaches the second time instance; and
dividing the accumulated sum by the difference between the second threshold and an acceleration value corresponding to zero acceleration.

9. The method of claim 8, wherein the first time instance is updated to the time corresponding to the sample that caused the accumulated sum to be set to zero; and wherein the duration is determined from the difference between the first and second time instances after the accumulation has stopped.

10. The method of claim 1, wherein determining the duration comprises determining a weighted integral of the acceleration measurement samples between the first and the second time instance.

11. The method of claim 1,
wherein the first threshold equals the second threshold, and
wherein determining the duration of the contact patch event comprises:
determining the first and the second time instance by extremizing an integral of the sequence of acceleration measurement samples; and
determining the duration of the contact patch event by dividing the value of the integral by a difference between the first or the second threshold and an acceleration value corresponding to zero acceleration.

12. The method of claim 1, wherein obtaining a sequence of acceleration measurement samples comprises obtaining, processing, and discarding a first set of measurement samples before a subsequent set is obtained.

13. The method of claim 8, wherein determining the duration comprises obtaining, processing, and discarding a first set of measurement samples before a subsequent set is obtained.

14. The method of claim 1, further comprising:
estimating a time window of the subsequent contact patch event based on the sequence of acceleration measurement samples, wherein the estimated time window comprises at least two time instances corresponding to the first and second time instance of a subsequent contact patch event; and
increasing a sample rate of the sequence of acceleration measurement samples during the estimated time window with respect to a reduced sample rate outside the estimated time window.

15. The method of claim 14, wherein estimating the time window of the subsequent contact patch event of the rolling tire comprises:
determining a rotational rate of the tire;
identifying a sample within the sequence of acceleration measurement samples of the rolling tire, indicative of a minimum radial acceleration; and
estimating a time window of the subsequent contact patch event of the rolling tire based on the identified sample and the rotational rate of the tire.

16. The method of claim 15, further comprising validating the estimated time window, wherein the method is aborted if the time window exceeds a predetermined threshold.

17. The method of claim 1, further comprising validating the sequence of samples, wherein the method is aborted if the samples exceed a predetermined threshold.

18. The method of claim 1, further comprising validating the determination of the duration of the contact patch event, wherein the method is aborted if the duration exceeds a predetermined threshold.

19. The method of claim 18, wherein validating the determination of the duration of the contact patch event further comprises:
comparing at least two determinations of the duration of at least one contact patch event wherein each of the at least two determinations is obtained with a different method; and
aborting the method if the at least two determinations differ by more than a predetermined threshold.

20. The method of claim 19, wherein the at least two determinations of the duration comprise:
a first determination obtained by:
determining the first time instance when the acceleration measurement samples cross the first threshold,
determining the second time instance when the acceleration measurement samples cross the second threshold after the first time instance, and
determining the duration from a difference between the first and the second time instance; and
a second determination obtained by:
determining a difference between the first or the second threshold and each sample of the sequence of acceleration measurement samples;
accumulating the difference into an accumulated sum;
setting the accumulated sum to zero whenever the accumulated sum is negative;
stopping the accumulation of the accumulated sum when the sequence of acceleration measurement samples reaches the second time instance
wherein the determination of the duration of the contact patch event comprises:
dividing the accumulated sum by the difference between the first threshold and an acceleration value corresponding to zero acceleration.

21. A tire-mounted TPMS component, comprising:
a tire-mounted acceleration sensor, the acceleration sensor being configured to generate a sequence of acceleration measurement samples of the rolling tire; and
an electronic control unit configured to determine the duration of the contact patch event based on acceleration measurement samples of the sequence between a first time instance when the acceleration measurement samples cross a first threshold and a second time instance when the acceleration measurement samples cross a second threshold.

22. The tire-mounted TPMS component of claim 21, further comprising:
wherein the electronic control unit is further configured to:
estimate a time window of the subsequent contact patch event based on the sequence of acceleration measurement samples, wherein the estimated time window comprises at least two time instances corresponding to the first and second time instance of a subsequent contact patch event; and
wherein the sensor is further configured to:
increase a sample rate of the sequence of acceleration measurement samples during the estimated time window with respect to a reduced sample rate outside the estimated time window.

23. A machine readable non-transitory storage including machine readable instructions to determine a duration of a contact patch event of a rolling tire, that when executed:
obtains a sequence of acceleration measurement samples of the rolling tire; and
determines the duration of the contact patch event based on acceleration measurement samples of the sequence between a first time instance when the acceleration measurement samples cross a first threshold and a second time instance when the acceleration measurement samples cross a second threshold.
